(19) United States
(12) Patent Application Publication
(10) Pub. No.: US 2015/0362871 A1
(43) Pub. Date: Dec. 17, 2015

(54) IMAGE FORMING APPARATUS AND METHOD OF CONTROLLING THE SAME

(71) Applicant: FUNAI ELECTRIC CO., LTD., Osaka (JP)

(72) Inventor: Katsuyoshi SANO, Nara-shi (JP)

(21) Appl. No.: 14/740,553

(22) Filed: Jun. 16, 2015

(30) Foreign Application Priority Data
Jun. 17, 2014 (JP) 2014-124628

(51) Int. Cl. G03G 15/16

(52) U.S. Cl. CPC G03G 15/1665

(57) ABSTRACT

An image forming apparatus includes: a photosensitive roller on which surface is formed an electrostatic latent image that is developed using a developer; a transfer roller for transferring the image developed on the surface of the photosensitive roller to a medium; an applying unit that applies voltage to the transfer roller; a current detecting unit that detects current flowing from the applying unit via the transfer roller and photosensitive roller; and a control unit that causes the applying unit to apply voltages of a first and a second voltage value, and determines a voltage value to be applied by the applying unit to transfer the image to the medium, using a difference between a first current value and a second current value which are current values obtained by the current detecting unit which are based on the first and second voltage values, respectively.

### CROSS REFERENCE TO RELATED APPLICATION

The present application is based on and claims priority of Japanese Patent Application No. 2014-124628 filed on Jun. 17, 2014. The entire disclosure of the above-identified application, including the specification, drawings and claims is incorporated herein by reference in its entirety.

### FIELD

The present invention relates to an image forming apparatus and a method of controlling the same.

### BACKGROUND

Image forming apparatuses that perform developing by causing a developer to adhere to the surface of a photosensitive roller on which an electrostatic latent image has been formed, and transfer the developed visible image onto a medium are conventionally known. In such an image forming apparatus, the medium is inserted between the photosensitive roller and a transfer roller when the visible image developed on the surface of the photosensitive roller is transferred to the medium. Accordingly, the visible image is transferred to the medium by applying, to the transfer roller, a bias voltage for attracting the charged developer. Here, the value of the bias voltage to be applied to the transfer roller is optimized to a value that allows the visible image to be accurately transferred to the medium.

Meanwhile, the electrical resistance of the transfer roller changes according to the environmental temperature and humidity. As such, the changing of the environmental temperature and humidity causes deterioration of the image that is transferred to the medium.

In view of this, the image forming apparatus described in Patent Literature (PTL) 1 optimizes the bias voltage by identifying the environment using the current that flows when a constant voltage is applied to the transfer roller.

### CITATION LIST

### Patent Literature

### [Patent Literature 1] Japanese Unexamined Patent Application Publication No. 2004-333792

### SUMMARY

### Technical Problem

However, in the image forming apparatus described in PTL 1, the current that flows to the transfer roller is affected by the potential of the photosensitive roller that opposes the transfer roller. Therefore, when the potential of the photosensitive roller is unstable, it is not always possible to have an accurate correspondence between the current that flows to the transfer roller and the environment, and thus the appropriate bias voltage cannot be applied to the transfer roller.

The present invention is conceived to solve the aforementioned problem and has as an object to provide an image forming apparatus capable of applying the appropriate bias voltage to the transfer roller according to the environment.

### Solution to Problem

In order to achieve the aforementioned object, an image forming apparatus according to an aspect of the present invention includes: a photosensitive roller on which surface is formed an electrostatic latent image that is developed using a developer; a transfer roller for transferring an image developed on the surface of the photosensitive roller to a medium; an applying unit that applies a voltage to the transfer roller; a current detecting unit that detects a current that flows from the applying unit via the transfer roller and the photosensitive roller; and a control unit that causes the applying unit to apply a voltage of a first voltage value and a voltage of a second voltage value, and determines a voltage value of the voltage to be applied by the applying unit to transfer the image to the medium, using a difference between a first current value and a second current value which are current values obtained by the current detecting unit, the first current value being based on the first voltage value, the second current value being based on the second voltage value.

Accordingly, the difference between the first current value and the second current value is used in order to determine the appropriate bias voltage for the transfer roller according to the environment. Here, in the difference between the first current value and the second current value, at least a portion of the error component included in each of the first current value and the second current value is suppressed, which allows the bias voltage for the transfer roller to be determined more accurately,

For example, when the difference is bigger, the control unit may determine a smaller value for the voltage value to be applied by the applying unit to transfer the image to the medium.

Accordingly, when the difference is big, that is, in the case of a high temperature, high humidity environment, the bias voltage for the transfer roller can be set to a low value. Furthermore, when the difference is small, that is, in the case of a low temperature, low humidity environment, the bias voltage for the transfer roller can be set to a high value.

For example, the control unit may cause the applying unit to apply a constant voltage from a first time point up to a second time point and apply the voltage of the first voltage value and the voltage of the second voltage value between a third time point and a fourth time point, the third time point being a time point after the photosensitive roller rotates once from the first time point, the fourth time point being a time point after the photosensitive roller rotates once from the second time point.

Accordingly, during the determining of the bias voltage of the transfer roller, the effect of the change in the potential of the photosensitive roller can be suppressed.

For example, the constant voltage may be a voltage for cleaning at least one of the photosensitive roller and the transfer roller.

Accordingly, a separate constant voltage need not be applied to the transfer roller for determining the bias voltage for the transfer roller, and the voltage applied for cleaning can be used effectively Therefore, power consumption and the time required for bias voltage determination can be reduced.

For example, the control unit may cause the applying unit to apply the voltage of the first voltage value and the voltage of the second voltage value to the transfer roller in a period in which at least one of the photosensitive roller and the transfer roller is cleaned.

Accordingly, the bias voltage for the transfer roller can be determined during the cleaning period.

For example, the constant voltage may be a negative voltage, and the voltage of the first voltage value and the voltage of the second voltage value may be positive voltages.

Accordingly, since the rate of change of the current that flows through the transfer roller against the bias voltage can be increased, relatively small values can be used for the first voltage value and the second voltage value.

For example, the current detecting unit may detect a current that flows from the applying unit to the transfer roller.

It should be noted that the present invention can be realized not only as an image forming apparatus including such characteristic processing units, but also as a control method including, as steps, the processes executed by the characteristic processing units included in the image forming apparatus. Furthermore, the present invention can also be realized as a program for causing a computer to function as the characteristic processing units included in the image forming apparatus or as a program which causes a computer to execute the characteristic steps included in the control method. In addition, it goes without saying that such a program can be distributed via a non-statutory computer-readable medium such as a CD-ROM (Compact Disc-Read Only Memory) and via a communication network such as the Internet.

### Advantageous Effects

The present invention can provide an image forming apparatus capable of applying the appropriate bias voltage to the transfer roller according to the environmental temperature and humidity.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a perspective view of the external appearance of an image forming apparatus according to Embodiment 1.

FIG. 2 is a cross-sectional view of an outline configuration of the image forming apparatus according to Embodiment 1.

FIG. 3 is a schematic diagram illustrating a transfer roller and structural elements related thereto according to Embodiment 1.

FIG. 4 is a graph illustrating the change over time of the potential of the transfer roller and the potential at a position in a photosensitive roller which opposes the transfer roller, in the image forming apparatus according to Embodiment 1.

FIG. 5 is a table showing the relationship between the optimum value for a bias voltage value for the transfer roller and the difference between detected current values.

FIG. 6 is a flowchart illustrating the flow of a method of controlling an image forming apparatus according to Embodiment 1.

FIG. 7 is a graph illustrating the change over time for the potential of the transfer roller and the potential at a position in a photosensitive roller which opposes the transfer roller, in an image forming apparatus according to Embodiment 2.

FIG. 8 is a graph illustrating the change over time for the potential of the transfer roller and the potential at a position in a photosensitive roller which opposes the transfer roller, in the image forming apparatus according to Embodiment 3.

### DESCRIPTION OF EMBODIMENTS

Hereinafter, exemplary embodiments of the present invention shall be described in detail using the Drawings. It should be noted that the embodiments described hereinafter illustrate preferred specific examples of the present invention. The numerical values, shapes, materials, structural elements, the arrangement and connection of the structural elements, steps, the processing order of the steps etc. shown in the following exemplary embodiments are mere examples, and therefore do not limit the present invention, the scope of which is defined in the appended Claims and their equivalents. The present invention is defined by the Claims. Therefore, among the structural elements in the following embodiments, structural elements not recited in an independent claim are not necessarily required to overcome the problem to be solved by the present invention, but are described as structural elements of a more preferable form.

### Embodiment 1

[Overall Configuration of Image Forming Apparatus]

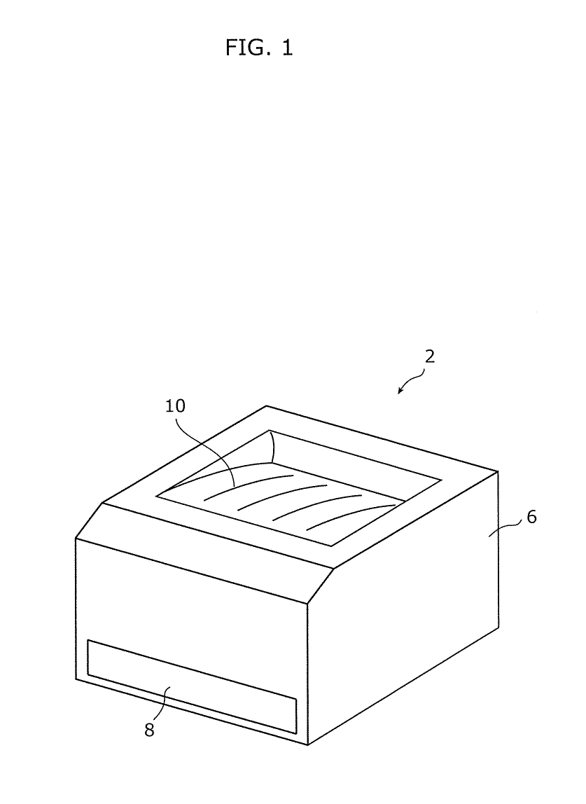

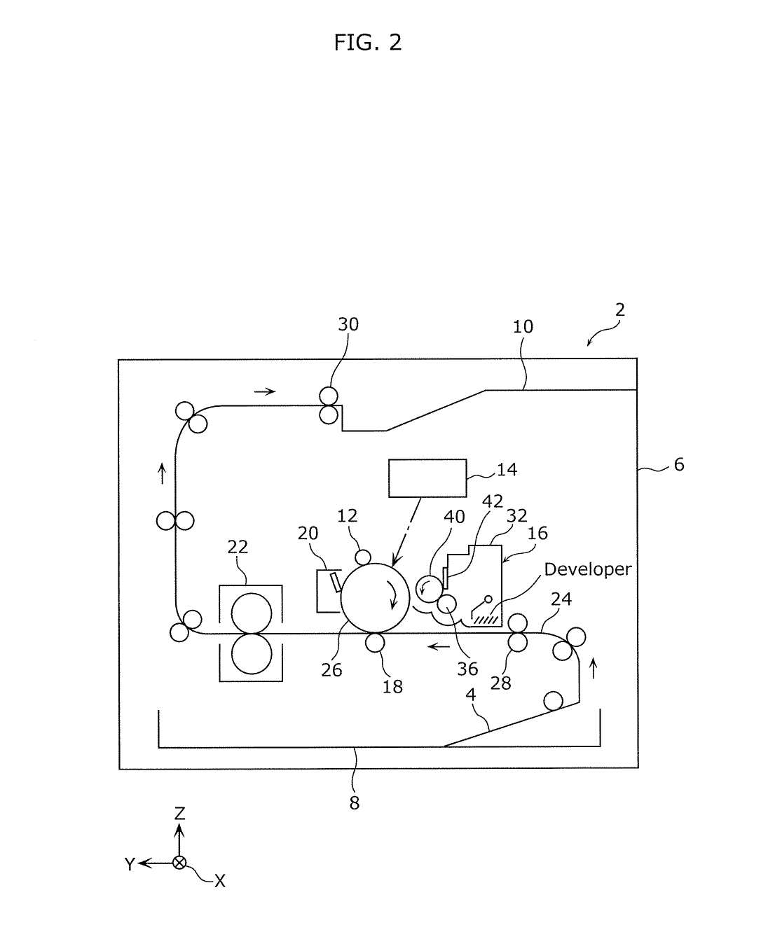

First, the overall configuration of an image forming apparatus according to Embodiment 1 is described with reference to FIG. 1 and FIG. 2

FIG. 1 is a perspective view of the external appearance of the image forming apparatus according to this embodiment.

FIG. 2 is a cross-sectional view of an outline configuration of the image forming apparatus according to this embodiment.

As illustrated in FIG. 1 and FIG. 2, an image forming apparatus 2 is a monochrome laser printer for forming an image on a medium 4, for example. It should be noted that medium 4 is, for example, regular paper or overhead projector (OHP) paper, etc.

As illustrated in FIG. 1, image forming apparatus 2 includes a chassis 6. A feeder 8 is provided in the front face of the chassis 6. The feeder 8 is for feeding the medium 4 onto which the image is to be formed, into the chassis 6. An ejecting unit 10 is provided in the top face of the chassis 6. The ejecting unit 10 is for ejecting the medium 4 onto which the image has been formed, outside of the chassis 6.

As illustrated in FIG. 2, a photosensitive roller 26, a charging roller 12, an exposing unit 14, a developing device 16, a transfer roller 18, a cleaning device 20, and a fuser 22 are disposed inside the chassis 6. It should be noted that a conveyance path 24 for conveying the medium 4 fed from the feeder 8 toward the ejecting unit 10 is formed inside the chassis 6. The medium 4 fed by the feeder 8 is conveyed along the conveyance path 24 by a pair of resist rollers 28.

The photosensitive roller 26 is a roller for forming an electrostatic latent image on the surface thereof. The photosensitive roller 26 is configured of a roller body formed from aluminum, and so on, and a photosensitive layer formed on the surface of the roller body. It should be noted that the photosensitive layer is formed from, for example, an organic photosensitive layer (OPC: organic photo conductor) or amorphous silicon (a-Si), etc. The rotational axis of the photosensitive roller 26 extends in the X-axis direction in FIG. 2, and rotates in a predetermined direction under the driving power of a motor (not illustrated).

The charging roller 12 is a charging device that charges the surface of the photosensitive roller 26 by applying voltage in a state where the charging roller is in contact with the surface of the photosensitive roller 26. It should be noted that, in place of the charging roller 12, the photosensitive roller 26 may be charged using, for example, a corona discharge device that discharges by applying high voltage using a narrow wire, or the like, as an electrode.

The exposing unit 14 forms the electrostatic latent image on the surface of the photosensitive roller 26 by irradiating the surface of the photosensitive roller 26 with a laser beam based on image data transmitted from an external personal computer, or the like (not illustrated).

The developing device 16 develops the electrostatic latent image by causing developer to adhere to the electrostatic latent image formed on the surface of the photosensitive roller 26. This forms a visible image on the surface of the photosensitive roller 26. In this embodiment, the developer is exemplified by a negatively charged toner.

As illustrated in FIG. 2, the developing device 16 includes a developer container 32, a feed roller 36 a developer roller 40, and a regulating blade 42.

The developer container 32 is a container that holds the developer.

The feed roller 36 is a roller disposed inside the developer container 32, and feeds the developer to the developer roller 40.

The developer roller 40 is a roller for developing the electrostatic latent image formed on the surface of the photosensitive roller 26, using the developer carried on the surface of the developer roller 40. The rotational axis line of the developer roller 40 is located substantially parallel to the rotational axis line of the photosensitive roller 26. The developer roller 40 rotates in a direction opposite the rotation direction of the photosensitive roller 26, under the driving force of a motor (not illustrated).

The regulating blade 42 is what is called a doctor blade, and is for regulating the thickness of the layer of developer that is carried on the surface of the developer roller 40.

The transfer roller 18 transfers the visible image formed on the surface of the photosensitive roller 26 to the medium 4 that is conveyed along the conveyance path 24 from the feeder 8. A bias voltage for attracting the developer that has adhered to the photosensitive roller 26 is applied to the transfer roller 18 by an applying unit (described later). In this embodiment, a negatively charged toner is used as the developer, and thus a positive bias voltage is applied to the transfer roller when transferring is performed. Furthermore, in the image forming apparatus 2 according to this embodiment, the current that flows from the applying unit to the transfer roller 18 due to the application of bias voltage to the transfer roller 18 is detected. Taking advantage of the fact that the detected current value is dependent on environmental temperature and humidity, the environment is detected based on the detected current value. Then, the bias voltage for transferring an image is determined according to the detected environment. The method of determining the bias voltage is described in detail later.

The cleaning device 20 removes the developer remaining on the surface of the photosensitive roller 26, after the visible image is transferred to the medium 4.

The fuser 22 fuses the visible image to the medium 4 by applying heat and pressure to the medium 4 onto which the visible image has been transferred. It should be noted that the medium 4 that has passed through the fuser 22 is ejected to the ejecting unit 10 by a pair of ejecting rollers 30.

[Transfer Roller Voltage Application Configuration]

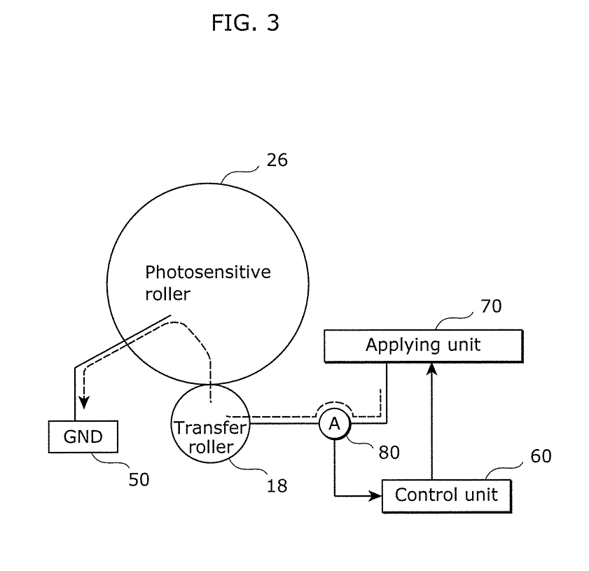

Next, the configuration for applying voltage to the transfer roller 18, which is a characteristic configuration according to this embodiment, is described with reference to FIG. 3.

FIG. 3 is a schematic diagram illustrating the transfer roller 18 and related structural elements according to this embodiment.

As illustrated in FIG. 3, the image forming apparatus 2 according to this embodiment includes, as structural elements for applying bias voltage to the transfer roller 18, a control unit 60, an applying unit 70, and a current detecting unit 80.

The applying unit 70 is a circuit for applying a bias voltage to the transfer roller 18.

The current detecting unit 80 is a detecting unit that detects current that flows from the applying unit 70 to a ground 50 via the transfer roller 18 and the photosensitive roller 26 (see broken line arrow in FIG. 3). It should be noted that although the current detecting unit 80 is provided between the applying unit 70 and the transfer roller 18 in this embodiment, the current detecting unit 80 may be provided between the photosensitive roller 26 and the ground 50.

The control unit 60 is a processing unit that receives input of a detected current value obtained by the current detecting unit 80, and controls the applying unit 70 based on the detected current value. More specifically, control unit 60 causes the applying unit 70 to apply a voltage of a first voltage value and a voltage of a second voltage value. The control unit 60 determines the voltage value to be applied by the applying unit 70 for transferring the image to the medium 4, by using the difference between a first current value and a second current value which are detected current values obtained by the current detecting unit 80 which are based on the first voltage value and the second voltage value, respectively. The method of determining the voltage value, etc., is described in detail later.

[Environment Detection Process]

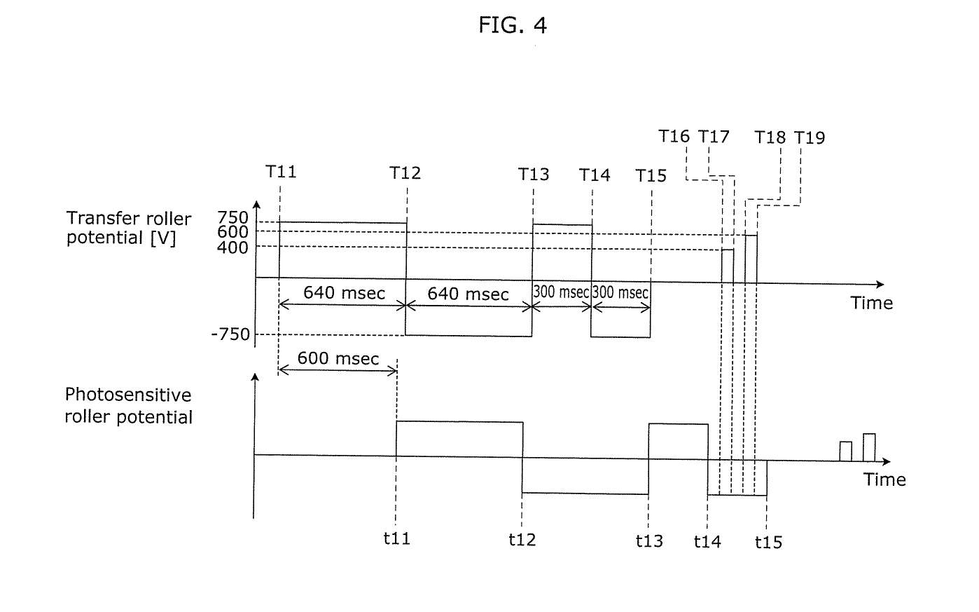

Next, the environment detection process is described using FIG. 4. In this embodiment, environment detection is performed in a period in which the potential of the photosensitive roller 26 becomes constant due to the bias voltage applied to the transfer roller 18 in a cleaning period of the image forming apparatus 2.

FIG. 4 is a graph illustrating the change over time of the (i) potential of the transfer roller 18 and (ii) the potential at a position in the photosensitive roller 26 which opposes the transfer roller 18, when environment detection is performed in the image forming apparatus 2 according to this embodiment.

The period from time T11 to time T15 illustrated in FIG. 4 denotes a cleaning period of the photosensitive roller 26 and the transfer roller 18, and the period from time T16 to time T19 denotes a voltage application period for environment detection.

The cleaning period is a period for removing the developer which was not removed by the cleaning device 20 and remains on at least one of the photosensitive roller 26 and the transfer roller 18.

Out of the aforementioned cleaning period, the period from time T11 to time T13 for cleaning the photosensitive roller 26 will be described first. In the period from time T11 to time T12, a positive bias voltage is applied to the transfer roller 18, and thus the developer remaining on the photosensitive roller 26 is attracted to the transfer roller 18. Here, the rotation period of the photosensitive roller 26 is exemplified in this embodiment as being 600 msec. As such, setting the length of the period from time T11 to time T12 to 640 msec, which is longer than the rotation period of the photosensitive roller 26 allows the developer on the entire circumference of the photosensitive roller 26 to be attracted to the transfer roller 18. Next, in the period from time T12 to time T13 (640 msec long), a negative bias voltage is applied to the transfer roller 18, and thus the developer that was attracted to the transfer roller 18 returns again to the photosensitive roller 26. Then, the photosensitive roller 26 is cleaned by way of the cleaning device 20 removing the developer that has returned to the photosensitive roller 26.

Next, out of the aforementioned cleaning period, the period from time T13 to time T15 for cleaning the transfer roller 18 will be described. In the period from time T13 to time T14, a positive bias voltage is again applied to the transfer roller 18, and thus the developer is attracted to the transfer roller 18. Then, in the period from time T14 to time T15, a negative bias voltage is again applied to the transfer roller 18, and thus developer that was attracted to the transfer roller 18 returns to the photosensitive roller 26 and is removed by the cleaning device 20. Here, the rotation period of the transfer roller 18 is exemplified in this embodiment as being 250 msec, and the length of the period from time T13 to time T14 and the length of the period from time T14 to time T15 are set to 300 msec which is longer than the rotation period of the transfer roller 18. This allows the entire circumference of the transfer roller 18 to be cleaned.

In the above-described cleaning period, when a bias voltage is applied to the transfer roller 18, the potential at the position in the photosensitive roller 26 which opposes the transfer roller 18 is affected accordingly. Subsequently, the inventor has found that the portion of the photosensitive roller 26 which is affected by the transfer roller 18 rotates and returns again to the position which opposes the transfer roller 18, in a state where the effect of the potential is maintained. For example, as illustrated in FIG. 4, the potential at the position in the photosensitive roller 26 which opposes the transfer roller 18 is affected by the positive bias voltage applied to the transfer roller 18 at time T11 and rises. Then, at time t11 after a rotation period (600 msec) of the photosensitive roller 26, the portion of the photosensitive roller 26 having the raised potential returns again to the position which opposes the transfer roller 18, in a state where the raised potential is maintained. In the same manner, as illustrated in FIG. 4, the potential at the position in the photosensitive roller 26 which opposes the transfer roller 18 is affected by the change in the potential of the transfer roller 18 in a period from time T12 to time T15. Accordingly, the potential of the photosensitive roller 26 in a period from time t12 to time t15 changes. As described above, accurate environment detection cannot be performed because the detected current value of the current that flows through the transfer roller 18 when voltage is applied to the transfer roller 18 changes due to the change in the potential at the position in the photosensitive roller 26 which opposes the transfer roller 18.

In view of this, in this embodiment, the control unit 60 causes the applying unit 70 to apply the voltage of the first voltage value and the voltage of the second voltage value. Then, the control unit 60 detects the environment based on the difference between the first current value and the second current value which are the detected current values obtained by the current detecting unit 80 which are based on the first voltage value and the second voltage value, respectively. For example, the value corresponding to the electrical resistance of the transfer roller 18 can be calculated by calculating the ratio of the difference between the first current value and the second current value to the difference between the first voltage value and the second voltage value. With this, at least a portion of the error component included in each of the first current value and the second current value, which is caused by the potential of the photosensitive roller 26, etc., can be removed by calculating the difference between the first current value and the second current value. Therefore, by using the aforementioned ratio, more accurate environment detection can be performed, and thus a more appropriate bias voltage can be applied to the transfer roller 18. In this embodiment, 400 V is applied to the transfer roller 18, as the first voltage value, from time T16 to time T17, and 600 V is applied to the transfer roller 18, as the second voltage value, from time T18 to time T19.

In this embodiment, the timing for applying the aforementioned voltage of the first voltage value and the voltage of the second voltage value is adjusted in order to perform accurate environment detection more reliably. The application timing is described below.

As described above, the potential of photosensitive roller 26 is affected by the potential of the transfer roller 18, and so on, and changes. As such, there are cases where the potential of the photosensitive roller 26 changes while the voltage of the first voltage value and the voltage of the second voltage value are applied. In such a case, there is a possibility that the majority of the error component caused by potential of the photosensitive roller 26 cannot be removed even if the difference between the first current value and the second current value is calculated.

In view of this, in this embodiment, the application of the voltage of the first voltage value and the voltage of the second voltage value is performed in a period in which the potential at the position in the photosensitive roller 26 which opposes the transfer roller 18 is constant. In other words, the applying unit 70 applies a constant voltage from a first time point to a second time point, and applies the voltage of the first voltage value and the voltage of the second voltage value between a third time point and a fourth time point which are the time points after the photosensitive roller 26 rotates once from the first time point and the second time point, respectively. In this embodiment, the control unit 60 causes the applying unit 70 to apply a voltage of −750 V from time T14 (first time point) to time T15 (second time point), as illustrated in FIG. 4. Then, the control unit 60 causes the applying unit 70 to apply a voltage of 400 V and a voltage of 600 V between time t14 (third time point) and time t15 (fourth time point) which are the time points after the photosensitive roller 26 rotates once from time T14 and time T15, respectively. Here, the value corresponding to the electrical resistance of the transfer roller 18 is calculated by calculating the difference between the respective detected current values obtained by the current detecting unit 80 when the applying unit 70 applies the 400-V voltage and the 600-V voltage. As described above, the error component of the difference, which is caused by the change in the potential of the photosensitive roller 26 during environment detection, can be suppressed by performing the application of the voltage of the first voltage value and the voltage of the second voltage value in the period in which the potential at the position in the photosensitive roller 26 which opposes the transfer roller 18 is constant.

[Bias Voltage Optimization]

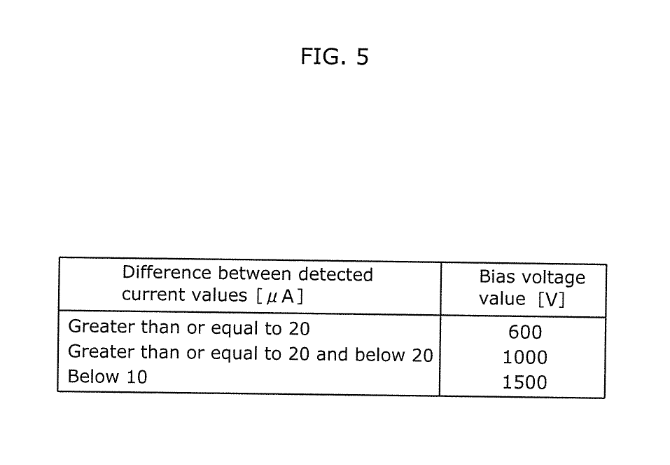

Next, the optimization of the bias voltage for the transfer roller 18 using the result of the above-described environment detection is described with reference to FIG. 5.

FIG. 5 is a table showing an example of the relationship between (i) the optimum value for the bias voltage value for the transfer roller 18 according to this embodiment and (ii) the difference between the detected current values obtained by the current detecting unit 80 when the voltage of the first voltage value and the voltage of the second voltage value are applied by the applying unit 70.

A bigger difference between the detected current values in FIG. 5 means the electrical resistance of the transfer roller 18 is smaller. Here, since the electrical resistance of the transfer roller 18 becomes small when the environment has high temperature and high humidity, it is understood that, when the difference between the detected current values is big, the environment has high temperature and high humidity. In a high temperature, high humidity environment, the amount of charge when the developer, which consists of a toner, is in a charged state tends to decrease, and thus the bias voltage for the transfer roller 18 is set lower. In this embodiment, when the difference between the detected current values is greater than or equal to 20 μA, the bias voltage for the transfer roller 18 is set to 600 V.

Furthermore, a smaller difference between the detected current values in FIG. 5 means the electrical resistance of the transfer roller 18 is bigger, that is, the environment has low temperature and low humidity. In a low temperature, low humidity environment, the electrical resistance component of the medium 4 becomes big, and thus defective transferring tends to occur. In view of this, in a low temperature, low humidity environment, the bias voltage for the transfer roller 18 is set higher. In this embodiment, when the difference between the detected current values is below 10 μA, the bias voltage for the transfer roller 18 is set to 1500 V.

Furthermore, it can be seen that, when the difference between the detected current values in FIG. 5 is greater than or equal to 10 μA and below 20 μA, the environment is an intermediate environment between the high temperature, high humidity environment and the low temperature, low humidity environment. In this embodiment, when the difference between the detected current values is greater than or equal to 10 μA and below 20 μA, the bias voltage for the transfer roller 18 is set to 1000 V.

As described above, environment detection can be performed using the difference between the respective detected current values obtained by the current detecting unit 80 when the voltage of the first voltage value and the voltage of the second voltage value are applied by the applying unit 70. In the environment detection, the effect of the change in the surface potential of the photosensitive roller 26 is suppressed. Furthermore, the voltage value to be applied by the applying unit 70 for transferring the image on the surface of the photosensitive roller 26 to the medium 4 can be optimized using the aforementioned difference.

[Control Method]

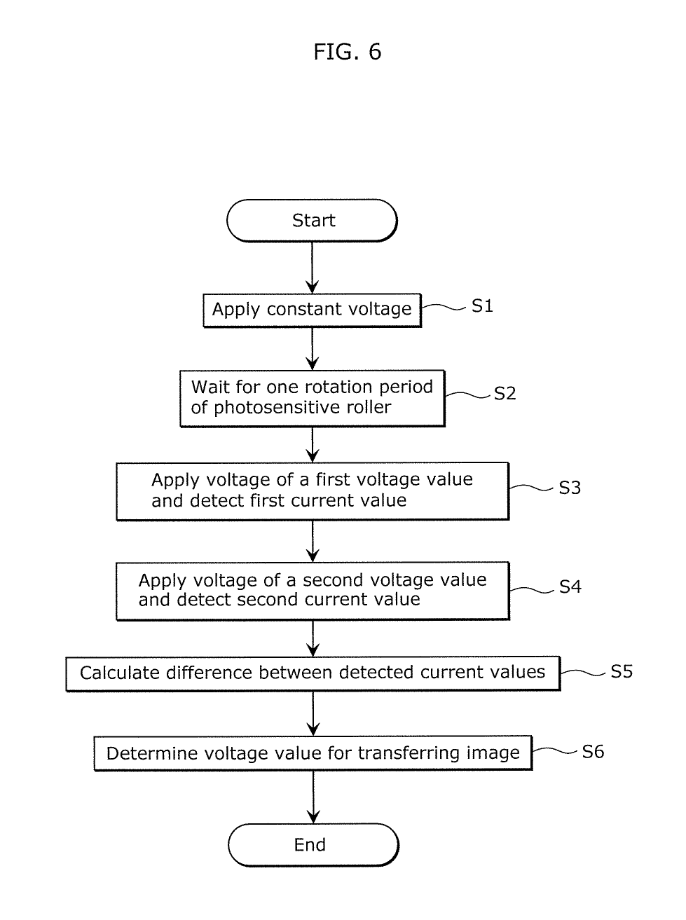

Next, a method of controlling when environment detection and bias voltage determination are performed in the image forming apparatus 2 according to this embodiment is described with reference to FIG. 6.

FIG. 6 is a flowchart illustrating the flow of the method of controlling the image forming apparatus 2 according to this embodiment.

First, the control unit 60 causes the applying unit 70 to apply a constant voltage (−750 V) to the transfer roller 18 from a first time point (time T14 in FIG. 4) to a second time point (time T15 in FIG. 4) (S1).

Next, the control unit 60 waits from the first time point up to when the transfer roller 18 rotates once (that is, until the time for one rotation period elapses) (S2). It should be noted that, here, the control unit 60 need not wait if the period in which the constant voltage is applied is longer than one rotation period of the photosensitive roller 26.

Next, the control unit 60 causes the applying unit 70 to apply the voltage of the first voltage value (400 V) to the transfer roller 18 between the third time point and the fourth time point which are the time points after the photosensitive roller 26 rotates once from the first time point and the second time point, respectively. In addition, the control unit 60 causes the current detecting unit 80 to detect the current value (first current value) of the current then flowing from the applying unit 70 to the transfer roller 18 (S3). Next, the control unit 60 causes the applying unit 70 to apply the voltage of the second voltage value (600 V) to the photosensitive roller 26 between the third time point and the fourth time point, and causes the current detecting unit 80 to detect the current value (second current value) of the current then flowing from the applying unit 70 to the transfer roller 18 (S4). It should be noted that if the period in which the constant voltage is applied is longer than one rotation period of the photosensitive roller 26, that is, if the second time point comes after the third time point, it is sufficient that the voltage of the first voltage value and the voltage of the second voltage value are applied between the second time point and the fourth time point.

Next, the control unit 60 calculates the difference between the first current value and the second current value (S5).

Next, the control unit 60 determines the voltage value of the voltage to be applied to the transfer roller 18 in order to transfer the image to the medium 4, using the calculated difference (S6). Here, the control unit 60 refers to a table, such as that illustrated in FIG. 5, in order to determine the voltage value. The table may be stored in a memory, or the like, inside the control unit 60, or may be stored in a memory, or the like, outside the control unit 60. Furthermore, a function indicating the relationship between the voltage value and the difference may be used in order for the control unit 60 to determine the voltage value.

By having the control unit 60 perform control in the manner described above, the voltage value to be applied to the transfer roller 18 for transferring the image to the medium 4 can be optimized according to the environment.

### Advantageous Effect

As described above, the image forming apparatus 2 according to this embodiment includes the control unit 60 that causes the applying unit 70 to apply a voltage of the first voltage value and a voltage of the second voltage value, and determines the voltage value to be applied by the applying unit 70 for transferring the image to the medium 4, using the difference between the first current value and the second current value which are detected current values obtained by the current detecting unit 80 and based on the first voltage value and the second voltage value, respectively.

Accordingly, the difference between the first current value and the second current value is used in determining an appropriate bias voltage for the transfer roller 18 according to the environment. Here, in the difference between the first current value and the second current value, at least a portion of the error component included in each of the first current value and the second current value is suppressed, which allows the bias voltage for the transfer roller 18 to be determined more accurately.

Furthermore, in the image forming apparatus 2 according to this embodiment, the control unit 60 causes the applying unit 70 to apply a constant voltage from a first time point up to a second time point, and apply the voltage of the first voltage value and the voltage of the second voltage value between a third time point and a fourth time point which are the time points after the photosensitive roller 26 rotates once from the first time point and the second time point, respectively.

Accordingly, in the determining of the bias voltage for the transfer roller 18, the effect of the change in the potential of the photosensitive roller 26 can be suppressed.

Furthermore, in the image forming apparatus 2 according to this embodiment, the aforementioned constant voltage is a voltage for cleaning at least on of the photosensitive roller 26 and the transfer roller 18.

Accordingly, a separate constant voltage need not be applied to the transfer roller 18 for determining the bias voltage for the transfer roller 18, and the voltage applied for cleaning can be used effectively. Therefore, power consumption and the time required for bias voltage determination can be reduced.

### Embodiment 2

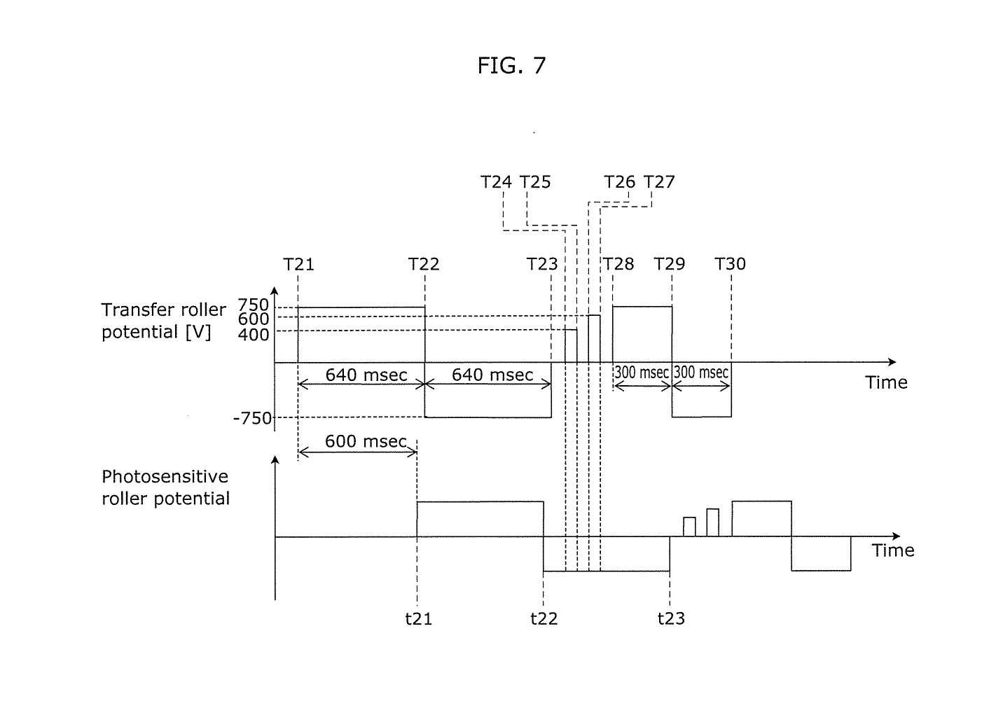

Next, an image forming apparatus according to Embodiment 2 is described. The image forming apparatus according to this embodiment is different from the image forming apparatus 2 according to Embodiment 1 in the timing for applying the voltages (voltage of the first voltage value and the voltage of the second voltage value) for environment detection to the transfer roller 18. Here, the image forming apparatus according to this embodiment is described centering on the aforementioned difference and with reference to FIG. 7.

FIG. 7 is a graph illustrating the change over time of the potential of the transfer roller 18 and the potential at a position in the photosensitive roller 26 which opposes the transfer roller 18, when environment detection is performed in the image forming apparatus according to this embodiment.

A period from time T21 to time T23 and a period from time T28 to time T30 in FIG. 7 are cleaning periods for the photosensitive roller 26 and the transfer roller 18, respectively. Furthermore, the voltage of the first voltage value (400 V) for environment detection is applied to the transfer roller 18 in the period from time T24 to time T25 in FIG. 7. Furthermore, the voltage of the second voltage value (600 V) for environment detection is applied to the transfer roller 18 in the period from time T26 to time T27.

As in Embodiment 1, in this embodiment, when the bias voltage is applied to the transfer roller 18, the potential at the position in the photosensitive roller 26 which opposes the transfer roller 18 is affected accordingly. For example, due to the effect of the potential of the transfer roller 18 in the cleaning period from time T21 to time T23, the potential at the position in the photosensitive roller 26 which opposes the transfer roller 18 changes in the period from time t21 to time t23.

Furthermore, as in Embodiment 1, in this embodiment, the voltages for environment detection are applied in the period in which the potential of the photosensitive roller 26 becomes constant (i.e., the period from time t22 to time t23). Therefore, it is possible to suppress the error in the difference between the detected current values caused by the change in the potential of the photosensitive roller 26 at the time of environment detection.

As described above, the image forming apparatus according to this embodiment is different from the image forming apparatus according to Embodiment 1 in terms of applying the voltage of the first voltage value and the voltage of the second voltage value for environment detection in between the cleaning periods. However, the same advantageous effect as the image forming apparatus according to Embodiment 1 can also be obtained with the image forming apparatus according to this embodiment.

### Embodiment 3

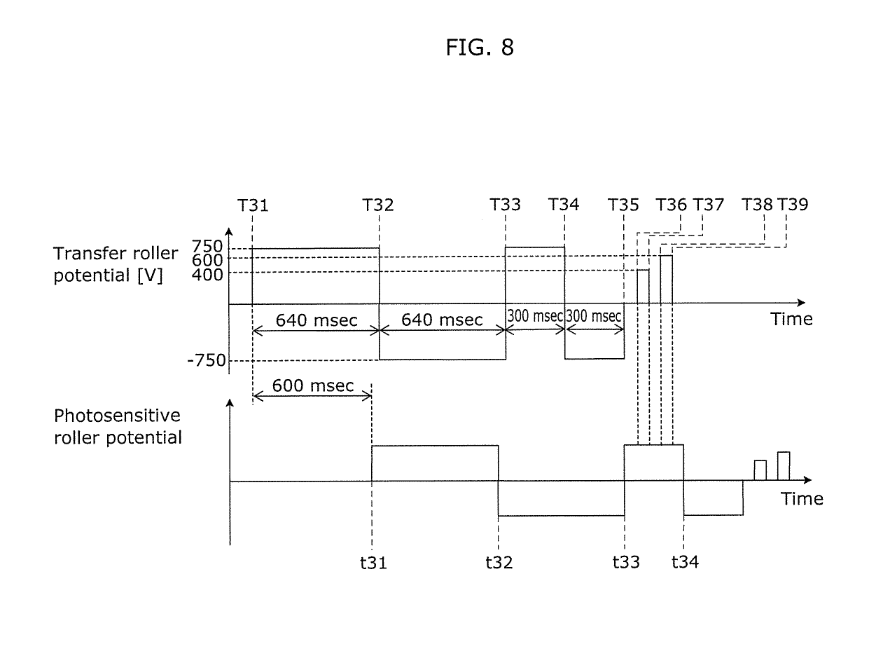

Next, an image forming apparatus according to Embodiment 3 is described. The image forming apparatus according to this embodiment is different from the image forming apparatuses according to Embodiment 1 and Embodiment 2 in terms of the timing for applying the voltages (voltage of the first voltage value and the voltage of the second voltage value) for environment detection to the transfer roller 18. Here, the image forming apparatus according to this embodiment is described centering on the aforementioned difference and with reference to FIG. 8.

FIG. 8 is a graph illustrating the change over time of the potential of the transfer roller 18 and the potential at a position in the photosensitive roller 26 which opposes the transfer roller 18, when environment detection is performed in the image forming apparatus according to this embodiment.

A period from time T31 to time T33 and a period from time T33 to time T35 in FIG. 8 are cleaning periods for the photosensitive roller 26 and the transfer roller 18, respectively. Furthermore, the voltage of the first voltage value (400 V) for environment detection is applied to the transfer roller 18 in the period from time T36 to time T37 in FIG. 8. Furthermore, the voltage of the second voltage value (600 V) for environment detection is applied to the transfer roller 18 in the period from time T38 to time T39.

As described above, as in Embodiment 1, in this embodiment, the voltages for environment detection are applied in a period (i.e., the period from time t33 to time t34) after the end of the cleaning periods, in which the potential of the photosensitive roller 26 is constant. However, this embodiment is different from Embodiment 1 in that the photosensitive roller 26 has a positive potential in the period in which the potential of the photosensitive roller 26 is constant. In this embodiment, the voltages for environment detection are applied in the period in which the potential of the photosensitive roller 26 is positive. As such, in this embodiment, the voltages for environment detection need to be set sufficiently higher than the potential of the photosensitive roller 26 to have a sufficient current flowing from the transfer roller 18 to the photosensitive roller 26.

As described above, the image forming apparatus according to this embodiment is different from the image forming apparatus according to Embodiment 1 in terms of applying the voltage of the first voltage value and the voltage of the second voltage value for environment detection in a period in which the potential of the photosensitive roller 23 is positive. However, by appropriately selecting the first voltage value and the second voltage value, the same advantageous effect as the image forming apparatus according to Embodiment 1 can be obtained with the image forming apparatus according to this embodiment.

### Variations, Etc.

Although the image forming apparatuses according to the embodiments of the present invention have been described up to this point, the present invention is not limited to these embodiments.

For example, numerical values, such as the bias voltage value for the transfer roller 18 and the voltage values for environment detection used in the each of the forgoing embodiments, are given as examples, and other numerical values may be used.

Furthermore, although a difference is used as the difference between the first current value and the second current value in the respective embodiments described above, the difference between the first current value and the second current value is not limited to this. For example, the ratio, etc., of values obtained by removing portions assumed to be error components from the first current value and the second current value may be used.

Furthermore, although each of the forgoing embodiments use a configuration in which the cleaning of the photosensitive roller 26 and the transfer roller 18 are performed in a cleaning period, it is also acceptable that only the cleaning of the photosensitive roller 26 is performed in the cleaning period.

Furthermore, although each of the forgoing embodiments uses a configuration in which the bias voltages for cleaning and the voltages for environment detection are applied separately, the voltages for environment detection may be applied during the application of the bias voltages for cleaning. In this case, a high voltage that allows cleaning to be sufficiently performed needs to be used for the voltages for environment detection. Furthermore, the rate of change of the current flowing through the transfer roller 18 against the bias voltage tends to decrease when bias voltage is high. Therefore, the values of the voltages for environment detection need to be set to values within a range in which the rate of change of the current flowing through the transfer roller 18 against the bias value does not become too small.

Furthermore, although optimization of the bias voltage for the transfer roller 18 is described in each of the forgoing embodiments, the bias voltages for the developer roller 40 and the charging roller 12 can also be optimized in the same manner. In other words, for the developer roller 40 and the charging roller 12, image quality can be improved by likewise setting the bias voltage low for a high temperature, high humidity environment and setting the bias voltage high for a low temperature, low humidity environment.

Furthermore, although the charged polarity of the developer is negative in each of the forgoing embodiments, the charged polarity may be positive. When the charged polarity of the developer is positive, it is sufficient that the polarity of the respective bias voltages be reversed in each of the forgoing embodiments.

Moreover, some or all of the structural elements included in each of the above-described apparatuses may be realized as a single system Large Scale Integration (LSI). The system LSI is a super multifunctional LSI manufactured by integrating a plurality of components onto a signal chip. More specifically, the system LSI is a computer system configured with a microprocessor, a ROM, a RAM, and so forth. The RAM stores a computer program. The microprocessor operates according to the computer program in order that a function of the system LSI is carried out.

Furthermore, some or all of the structural elements included in each of the above-described apparatuses may be implemented as an IC card or a standalone module that can be inserted into and removed from the corresponding apparatus. The IC card or the module is a computer system configured with a microprocessor, a ROM, a RAM, and so forth. The IC card or the module may include the aforementioned super multifunctional LSI. The microprocessor operates according to the computer program in order that a function of the IC card or the module is carried out. The IC card or the module may be tamper resistant.

Moreover, the present invention may be the method described above. Furthermore, the present invention may be a computer program for implementing such method using a computer, or may be a digital signal of the computer program.

In addition, the present invention may be the aforementioned computer program or digital signal recorded on a non-transitory computer-readable medium, such as a flexible disk, a hard disk, a CD-ROM, an MO, a DVD, a DVD-ROM, a DVD-RAM, a Blu-ray Disc (BD) (registered trademark), or a semiconductor memory. Also, the present invention may be the digital signal recorded on such non-transitory mediums.

Moreover, the present invention may be the aforementioned computer program or digital signal transmitted via a telecommunication line, a wireless or wired communication line, a network represented by the Internet, and data broadcasting.

Furthermore, the present invention may be a computer system including a microprocessor and a memory. The memory may store the aforementioned computer program and the microprocessor may operate according to the computer program.

Moreover, by transferring the non-transitory medium having the aforementioned program or digital signal recorded thereon or by transferring the aforementioned program or digital signal via the aforementioned network or the like, the present invention may be implemented by a different independent computer system.

In addition, the above-described exemplary embodiments and the above-described modifications may be combined with each other.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

Image forming apparatuses according to the present invention can be applied to, for example, a monochrome laser printer, a color laser printer, etc.

1. An image forming apparatus comprising:
a photosensitive roller on which surface is formed an electrostatic latent image that is developed using a developer;
a transfer roller for transferring an image developed on the surface of the photosensitive roller to a medium;
an applying unit that applies a voltage to the transfer roller;
a current detecting unit that detects a current that flows from the applying unit via the transfer roller and the photosensitive roller; and
a control unit that causes the applying unit to apply a voltage of a first voltage value and a voltage of a second voltage value, and determines a voltage value of the voltage to be applied by the applying unit to the transfer roller, based on a difference between a first current value and a second current value which are current values obtained by the current detecting unit, the first current value being based on the first voltage value, the second current value being based on the second voltage value.

2. The image forming apparatus according to claim 1,
wherein, when the difference is bigger, the control unit determines a smaller value for the voltage value to be applied by the applying unit.

3. The image forming apparatus according to claim 1,
wherein the control unit causes the applying unit to apply a constant voltage from a first time point up to a second time point and apply the voltage of the first voltage value and the voltage of the second voltage value between a third time point and a fourth time point, the third time point being a time point after the photosensitive roller rotates once from the first time point, the fourth time point being a time point after the photosensitive roller rotates once from the second time point.

4. The image forming apparatus according to claim 3,
wherein the constant voltage is a voltage for cleaning at least one of the photosensitive roller and the transfer roller.

5. The image forming apparatus according to claim 3,
wherein the control unit causes the applying unit to apply the voltage of the first voltage value and the voltage of the second voltage value to the transfer roller in a period in which at least one of the photosensitive roller and the transfer roller is cleaned.

6. The image forming apparatus according to claim 3,
wherein the constant voltage is a negative voltage, and
the voltage of the first voltage value and the voltage of the second voltage value are positive voltages.

7. The image forming apparatus according to claim 1,
wherein the current detecting unit detects a current that flows from the applying unit to the transfer roller.

8. A method of controlling an image forming apparatus, the image forming apparatus including:
a photosensitive roller on which surface is formed an image that is developed using a developer;
a transfer roller for transferring an image developed on the surface of the photosensitive roller to a medium;
an applying unit that applies a voltage to the transfer roller; and
a current detecting unit that detects a current that flows from the applying unit via the transfer roller and the photosensitive roller,
the method comprising:
applying a voltage of a first voltage value and a voltage of a second voltage value performed by the applying unit; and
determining the voltage value of the voltage to be applied by applying unit to the transfer roller, based on a difference between a first current value and a second current value which are current values obtained by the current detecting unit, the first current value being based on the first voltage value, the second current value being based on the second voltage value.

9. The method according to claim 8,
wherein in the determining, when the difference is bigger, a smaller value is determined for the voltage value.

10. The method according to claim 8,
wherein in the applying, a constant voltage is applied from a first time point up to a second time point and the voltage of the first voltage value and the voltage of the second voltage value are applied between a third time point and a fourth time point, by the applying unit, the third time point being a time point after the photosensitive roller rotates once from the first time point, the fourth time point being a time point after the photosensitive roller rotates once from the second time point.
